(19) United States
(12) Patent Application Publication
(10) Pub. No.: US 2025/0240135 A1
(43) Pub. Date: Jul. 24, 2025

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 18/855,388

(22) PCT Filed: Apr. 18, 2022
(86) PCT No.: PCT/CN2022/087498

§ 371 Date: Oct. 9, 2024

(51) Int. Cl. H04L 5/00; H04W 74/0833

(52) U.S. Cl. CPC H04L 5/0048; H04L 5/0091; H04W 74/0833

(57) ABSTRACT

Embodiments of the present disclosure relate to methods, devices and computer readable media for communication. A terminal device receives, from a first network device, a lower-layer signaling indicating a cell change or addition for a cell of a second network device and indicating a TCI state for the cell. The terminal device determines a RS associated with the TCI state, and performs, based on the RS, a RA procedure for the cell change or addition. In this way, latency for a L1/L2 based mobility procedure may be reduced.

### TECHNICAL FIELD

Embodiments of the present disclosure generally relate to the field of telecommunication, and in particular, to methods, devices and computer storage media of communication based on a lower-layer signaling.

### BACKGROUND

When user equipment (UE) moves from a coverage area of one cell to that of another cell, a change or addition or release of a serving cell may need to be performed. Currently, the change or addition or release of the serving cell is triggered by layer 3 (L3) measurements and is done by radio resource control (RRC) signaling triggered Reconfiguration with Synchronization for change of primary cell (PCell) and primary secondary cell (PSCell). All cases involve complete layer 2 (L2) and layer 1 (L1) resets, leading to longer latency, larger overhead and longer interruption time than beam switch mobility.

Some solutions to the above issue are proposed based on a lower-layer signaling such as layer 1 (L1) or layer 2 (L2) signaling. In one solution, a data transmission is performed with a change of a serving cell upon reception of the lower-layer signaling, which is also referred to as a L1/L2 based mobility. In this way, the latency, overhead and interruption time may be reduced. However, more details of implementing a L1/L2 based mobility procedure need to be further developed.

### SUMMARY

In general, embodiments of the present disclosure provide methods, devices and computer storage media of communication based on a lower-layer signaling.

In a first aspect, there is provided a method of communication. The method comprises: receiving, at a terminal device and from a first network device, a lower-layer signaling indicating a cell change or addition for a cell of a second network device and indicating a transmission configuration indicator state for the cell; determining a reference signal associated with the transmission configuration indicator state; and performing, based on the reference signal, a random access procedure for the cell change or addition.

In a second aspect, there is provided a method of communication. The method comprises: receiving, at a terminal device and from a first network device, a lower-layer signaling indicating a cell change or addition for a cell of a second network device and indicating a transmission configuration indicator state for the cell; performing a random access procedure for the cell change or addition; and determining, after completion of the random access procedure, that a demodulation reference signal antenna port for physical downlink control channel receptions is quasi co-located with a reference signal associated with the transmission configuration indicator state.

In a third aspect, there is provided a method of communication. The method comprises: receiving, at a terminal device and from a network device, a random access configuration dedicated for a cell change or addition based on a lower-layer signaling; and in response to receiving the lower-layer signaling, performing the cell change or addition based on the random access configuration.

In a fourth aspect, there is provided a method of communication. The method comprises: determining, at a terminal device, whether a radio link failure report is triggered by a failure in a lower-layer signaling based handover; and in accordance with a determination that the radio link failure report is triggered by the failure in the lower-layer signaling based handover, transmitting, to a network device, the radio link failure report comprising an indication that a last handover is the lower-layer signaling based handover.

In a fifth aspect, there is provided a method of communication. The method comprises: transmitting, at a first network device and to a terminal device, a lower-layer signaling indicating a cell change or addition for a cell of a second network device and indicating a transmission configuration indicator state for the cell; determining a reference signal associated with the transmission configuration indicator state; and performing, based on the reference signal, a random access procedure for the cell change or addition.

In a sixth aspect, there is provided a method of communication. The method comprises: transmitting, at a first network device and to a terminal device, a lower-layer signaling indicating a cell change or addition for a cell of a second network device and indicating a transmission configuration indicator state for the cell; performing a random access procedure for the cell change or addition; and determining, after completion of the random access procedure, that a demodulation reference signal antenna port for physical downlink control channel transmissions is quasi co-located with a reference signal associated with the transmission configuration indicator state.

In a seventh aspect, there is provided a method of communication. The method comprises: generating, at a first network device, a random access configuration dedicated for a cell change or addition based on a lower-layer signaling; and transmitting the random access configuration to a terminal device.

In an eighth aspect, there is provided a method of communication. The method comprises: receiving, at a network device and from a terminal device, a radio link failure report comprising an indication that a last handover is a lower-layer signaling based handover; and adjusting parameters for the lower-layer signaling based handover.

In a ninth aspect, there is provided a terminal device. The terminal device comprises a processor configured to perform the method according to any of the first to fourth aspects of the present disclosure.

In a tenth aspect, there is provided a network device. The network device comprises a processor configured to perform the method according to any of the fifth to eighth aspects of the present disclosure.

In an eleventh aspect, there is provided a computer readable medium having instructions stored thereon. The instructions, when executed on at least one processor, cause the at least one processor to perform the method according to any of the first to fourth aspects of the present disclosure.

In a twelfth aspect, there is provided a computer readable medium having instructions stored thereon. The instructions, when executed on at least one processor, cause the at least one processor to perform the method according to any of the fifth to eighth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture in which some embodiments of the present disclosure can be implemented;

FIG. 1E illustrates a schematic diagram illustrating a process of L1/L2 based mobility in which some embodiments of the present disclosure can be implemented;

FIG. 2 illustrates a schematic diagram illustrating a process of performing a RA procedure in L1/L2 based mobility according to embodiments of the present disclosure;

FIG. 3 illustrates a schematic diagram illustrating another process of performing a RA procedure in L1/L2 based mobility according to embodiments of the present disclosure;

FIG. 4 illustrates a schematic diagram illustrating a process of performing a L1/L2 based mobility procedure according to embodiments of the present disclosure;

FIG. 5 illustrates a schematic diagram illustrating a process of a radio link failure (RLF) report for a L1/L2 based handover according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure;

FIG. 8 illustrates still another example method of communication implemented at a terminal device in accordance with some embodiments of the present disclosure;

FIG. 9 illustrates yet another example method of communication implemented at a terminal device in accordance with some embodiments of the present disclosure;

FIG. 10 illustrates an example method of communication implemented at a network device in accordance with some embodiments of the present disclosure;

FIG. 11 illustrates another example method of communication implemented at a network device in accordance with some embodiments of the present disclosure;

FIG. 12 illustrates still another example method of communication implemented at a network device in accordance with some embodiments of the present disclosure;

FIG. 13 illustrates yet another example method of communication implemented at a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell change or addition” may be interchangeably used with “reconfiguration with sync for secondary cell group (SCG) or master cell group (MCG)”. The term “PSCell” refers to a SpCell of a SCG, the term “PCell” refers to a SpCell of a MCG, and the term “SpCell” refers to a primary cell of a SCG or MCG. The term “SCell” refers to a Secondary Cell. The term “L1/L2 based mobility” may be interchangeably used with “L1/L2 based mobility procedure” or “a cell change or addition based on a lower-layer signaling” or “L1/L2 based handover”. The term “lower-layer signaling” may be interchangeably used with “L1/L2 signaling”. The term “RRC reconfiguration” may be interchangeably used with “RRC reconfiguration message”. The term “data transmission” refers to the transmitting and receiving of data.

Currently, it is proposed to specify mechanisms and procedures of L1/L2 based mobility for mobility latency reduction for the following aspects:
configuration and maintenance for multiple candidate cells to allow fast application of configurations for candidate cells;
dynamic switch mechanism among candidate serving cells (including SpCell and SCell) for the potential applicable scenarios based on L1/L2 signaling;
L1 enhancements for inter-cell beam management, including L1 measurement and reporting, and beam indication;
timing advance (TA) management;
CU-DU interface signaling to support L1/L2 mobility, if needed.

The procedure of L1/L2 based mobility may be applicable to the following scenarios:
standalone, carrier aggregation (CA) and new radio (NR)-dual connectivity (DC) case with serving cell change within one cell group (CG);
intra-DU case and intra-CU inter-DU case (applicable for Standalone and CA: no new RAN interfaces are expected);
both intra-frequency and inter-frequency;
both frequency range 1 (FR1) and frequency range 2 (FR2);
source and target cells may be synchronized or non-synchronized.

Embodiments of the present disclosure provide improved solutions of communication for L1/L2 based mobility so as to achieve mobility latency reduction and other potential advantages.

In one aspect, a RA procedure is performed on beams associated with a transmission configuration indicator (TCI) state indicated in L1/L2 signaling. In this way, there is no need for the network to send another L1/L2 signaling to activate the TCI state, and thus communication latency may be reduced accordingly.

In another aspect, a TCI state indicated in L1/L2 signaling is used for physical downlink control channel (PDCCH) reception after completion of a RA procedure. In this way, there is also no need for a network to send another L1/L2 signaling to activate the TCI state, and thus communication latency may be reduced accordingly.

In still another aspect, a dedicated RA configuration is used for L1/L2 based mobility. In this way, performance of a RA procedure for L1/L2 based mobility may be improved.

In yet another aspect, an indication is added in a RLF report for L1/L2 based mobility if the RLF report is triggered by L1/L2 based handover. In this way, the network may be aware of a failure due to too early or too late L1/L2 based handover, and then may further adjust parameters for L1/L2 based handover.

Principles and implementations of the present disclosure will be described in detail below with reference to the figures.

### Example of Communication Network

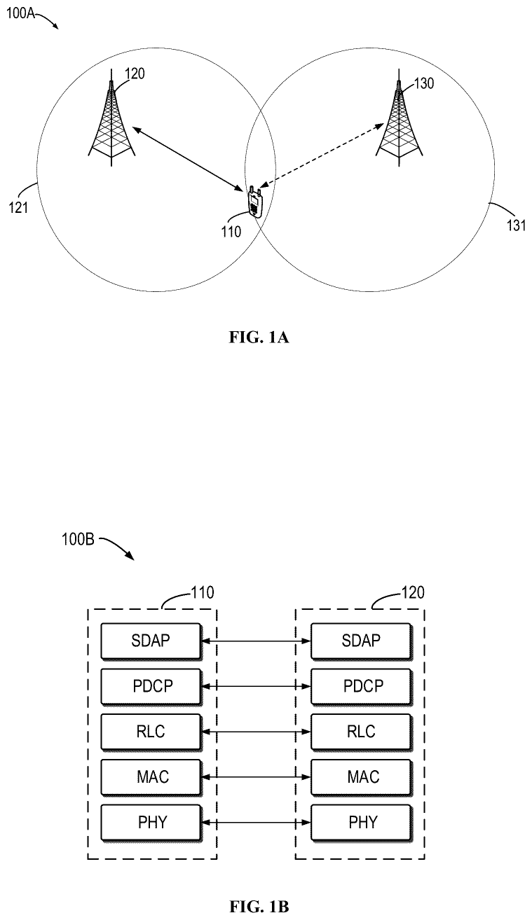

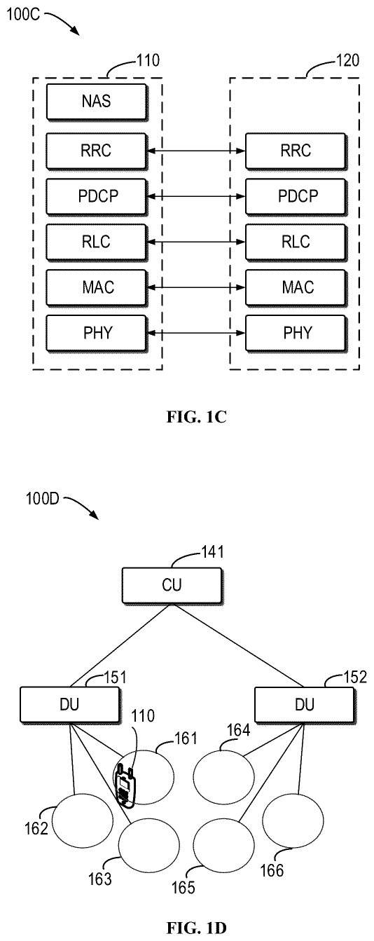

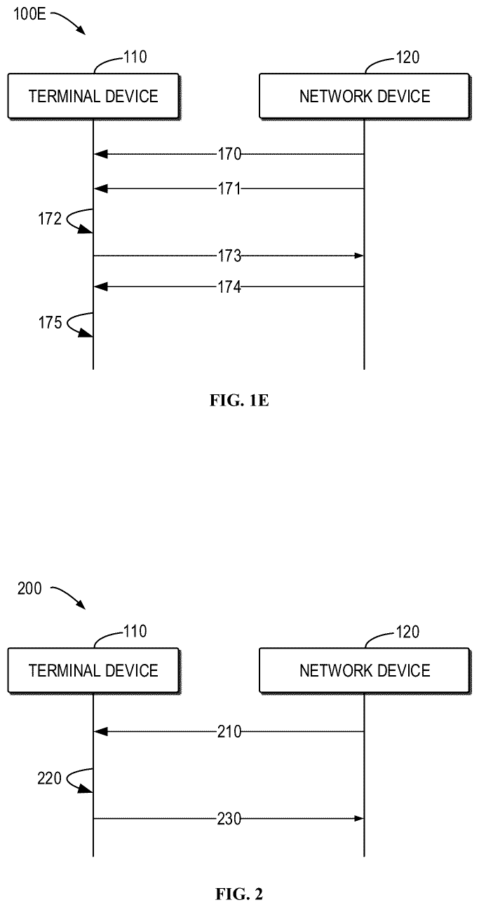

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 or 130 is referred to as UL communication, while communication in a reverse direction from the network device 120 or 130 towards the terminal device 110 is referred to as DL communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture in which some embodiments of the present disclosure can be implemented. The CU/DU architecture may be established at a network device.

As shown in FIG. 1D, CU 141 is shown. It is to be understood that more CUs may be comprised in the UP. The CU 141 may communicate with multiple DUs. Here, two DUs 151 and 152 are shown for illustration. It is to be understood that more DUs may also be provided for implementation of embodiments of the present disclosure. Although not shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may communicate with transmission and reception points (TRPs) 161, 162 and 163. DU 152 may communicate with TRPs 164, 165 and 166. One or multiple cells may be supported within each TRP. It is to be understood that this is merely an example, and more or less TRPs are also feasible. The terminal device 110 may communicate with any of these TRPs.

In some embodiments, the terminal device 110 may switch from one TRP to another TRP under control of the same CU and same DU. For example, the terminal device 110 may be handed over from one cell of TRP 161 to another cell of TRP 162. This is called as an intra-CU intra-DU serving cell change. In some embodiments, the terminal device 110 may switch from one TRP to another TRP under control of the same CU and different DUs. For example, the terminal device 110 may be handed over from one cell of TRP 162 to another cell of TRP 164. In this case, a cell change from one cell of DU 151 to another cell of DU 152 will occur. This is called as an intra-CU inter-DU serving cell change. In another example, the terminal device 110 may be handed over from a cell of one TRP to a cell of another TRP under control of different CUs. In this case, a handover from a CU to another CU will occur. This is called as an inter-CU handover.

The network device 120 and the network device 130 may correspond to one or two devices under the same CU. In some embodiments, the network device 120 and the network device 130 may correspond to different TRPs under the same DU. In some embodiments, the network device 120 and the network device 130 may correspond to different TRPs under different DUs.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 131. This is called as a handover. In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 131. This is called as a PScell change.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with an addition, modification or change of the serving cell. This procedure is called as the L1/L2 based mobility.

FIG. 1E illustrates a schematic diagram illustrating a process 100E of L1/L2 based mobility in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 1E, the network device 120 may transmit 170, to the terminal device 110, a RRC reconfiguration comprising a set of RRC configurations corresponding to a set of candidate cells allowing L1/L2 based mobility. The network device 120 may also transmit 171, to the terminal device 110, a configuration of beams (for example, a synchronization signal and physical broadcast channel (SSB) or a channel state information-reference signal (CSI-RS)) of a candidate cell for L1 measurement.

The terminal device 110 may perform 172 the L1 measurement based on the configuration. If a certain condition is fulfilled by a beam, e.g., quality of the beam is above threshold quality, the terminal device 110 may report 173 an indication of the beam (e.g., an identity (ID) associated with the beam) to the network device 120.

The network device 120 may transmit 174, to the terminal device 110, a L1/L2 signaling (e.g., downlink control information (DCI) or a medium access control (MAC) control element (CE)). The L1/L2 signaling indicates that TCI state(s) for a cell among candidate cells are activated along with a cell change or addition.

Upon reception of the L1/L2 signaling, the terminal device 110 may perform 175 the cell change or addition. For example, the lower layer (e.g., PHY or MAC layer) of the terminal device 110 indicates, to the RRC layer of the terminal device 110, information of the cell change or addition, e.g. an ID associated with the target cell. Upon reception of the indication, the RRC layer performs the cell change or addition by applying the RRC configuration corresponding to the target cell. The target cell may be PCell, PSCell or SCell of the terminal device 110. And the terminal device 110 may start a data transmission with the target cell using a pre-configured UE-dedicated channel and the activated TCI states.

Embodiments of the present disclosure provide improve solutions for a L1/L2 based mobility procedure. Their details will be described with reference to FIGS. 2 to 5.

### Example Implementation of Fix Beam for RA Procedure

In traditional reconfiguration with sync (handover or PSCell change), if a UE has been provided a configuration of more than one TCI states by RRC signaling, before the network sends a MAC CE to active one TCI state for a control resource set (CORESET) after a RA procedure, the UE assumes that a demodulation-reference signal (DM-RS) antenna port associated with PDCCH receptions is quasi co-located with a beam (SSB or CSI-RS) the UE identified during the RA procedure.

For L1/L2 based mobility, a L1/L2 signaling (e.g. MAC CE) may indicate a TCI state and cell change/addition. However, during a RA procedure, it is possible that the UE select a beam different from the beam associated with the indicated TCI state. Therefore, if the UE follow the current behavior that UE shall use the beam selected during RA procedure, it is possible that the TCI state being activated by the L1/L2 signaling which triggers mobility still not able to be used after the RA procedure, and the network has to send a MAC CE if the network still want to use the TCI state.

In view of this, embodiments of the present disclosure provide a solution of performing a RA procedure with a fix beam to solve the above and other potential issues. For illustration, the solution will be described below in connection with FIG. 2.

FIG. 2 illustrates a schematic diagram illustrating a process 200 of performing a RA procedure in L1/L2 based mobility according to embodiments of the present disclosure. For the purpose of discussion, the process 200 will be described with reference to FIG. 1A. The process 200 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 2, the network device 120 transmits 210, to the terminal device 110, a lower-layer signaling (i.e., L1/L2 signaling) indicating a cell change or addition for a cell (i.e., a target cell) of the network device 130. The lower-layer signaling further indicates a TCI state for the cell. In some embodiments, the cell change or addition may be a PCell change or addition. In some embodiments, the cell change or addition may be a PSCell change or addition. In some embodiments, the cell change or addition may be a SCell change or addition.

For example, a lower-layer signaling may indicate a cell change from a serving cell of network device 120 to the cell of the network device 130. As another example, a lower-layer signaling may indicate an addition of the cell of the network device 130. The cell may be PCell or PSCell of the terminal device 110. In some embodiments, the lower-layer signaling may be carried in DCI. In some embodiments, the lower-layer signaling may be carried in a MAC CE. Of course, any other suitable forms are also feasible.

Upon reception of the lower-layer signaling, the terminal device 110 determines 220 a reference signal (RS) indicated in the lower-layer signaling. In some embodiments, the RS may be a synchronization signal and physical broadcast channel block (SSB). In some embodiments, the RS may be a channel state information-reference signal (CSI-RS). Of course, the RS may adopt any other suitable forms. The terminal device 110 performs a RA procedure based on the RS. In other words, the terminal device 110 selects the RS during a RA resource selection.

In some embodiments, the terminal device 110 receives a L1/L2 based signaling which indicates a cell change or addition and also indicates a TCI state (for example, TCI state ID) for the target cell, and the terminal device 110 selects a RS associated with the TCI sate indicated in the L1/L2 based signaling during a RA resource selection. For example, if a RA procedure is initiated for L1/L2 based mobility, the terminal device 110 selects a SSB or CSI-RS associated with the indicated TCI state in the L1/L2 based signaling (e.g., MAC CE).

In some embodiments, multiple RSs may be associated with the TCI state. In these embodiments, the terminal device 110 may select, from the multiple RSs, a RS (for convenience, also referred to as a first RS herein) having a quasi-colocation (QCL) type of type D and determine the first RS as the RS associated with the TCI state. In other words, if the TCI state indicated in the lower-layer signaling is associated with two RSs, the terminal device 110 may select a RS of which the QCL type is type D. It is to be noted that any other suitable ways are also feasible.

Upon determination of the RS associated with the TCI state, the terminal device 110 performs 230 a RA procedure on the cell based on the RS.

In some embodiments, applying the process 200 only for the case of CORESET with index 0 is configured.

With the process 200, a RA procedure for L1/L2 based mobility is performed on a fix beam associated with a TCI state indicated in the L1/L2 signaling. Thus, there is no need for the network to send another L1/L2 signaling to activate the TCI state, and communication latency and overhead is reduced.

Example Implementation of Beam Usage after RA Procedure

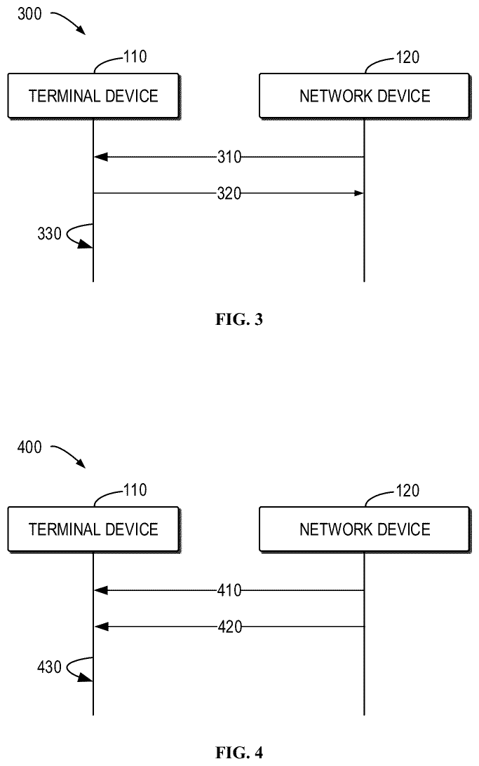

In view of the above issue, embodiments of the present disclosure also provide another solution for beam usage after a RA procedure. This solution will be described in connection with FIG. 3.

FIG. 3 illustrates a schematic diagram illustrating another process 300 of performing a RA procedure in L1/L2 based mobility according to embodiments of the present disclosure. For the purpose of discussion, the process 300 will be described with reference to FIG. 1A. The process 300 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 3, the network device 120 transmits 310, to the terminal device 110, a lower-layer signaling (i.e., L1/L2 signaling) indicating a cell change or addition for a cell (i.e., a target cell) of the network device 130. The lower-layer signaling further indicates a TCI state for the cell. In some embodiments, the cell change or addition may be a PCell change or addition. In some embodiments, the cell change or addition may be a PSCell change or addition. In some embodiments, the cell change or addition may be a SCell change or addition.

For example, a lower-layer signaling may indicate a cell change from a serving cell of network device 120 to the cell of the network device 130. As another example, a lower-layer signaling may indicate an addition of the cell of the network device 130. The cell may be PCell or PSCell of the terminal device 110. In some embodiments, the lower-layer signaling may be carried in DCI. In some embodiments, the lower-layer signaling may be carried in a MAC CE. Of course, any other suitable forms are also feasible.

Upon reception of the lower-layer signaling, the terminal device 110 performs 320 a RA procedure for the cell change or addition. In other words, the terminal device 110 follows a traditional behavior on a RS selection in the RA resource selection.

After completion of the RA procedure, the terminal device 110 determines 330 that a DM-RS antenna port for PDCCH receptions is quasi co-located with a RS associated with the TCI state. In other words, the terminal device 110 uses the activated TCI state for PDCCH receptions in the L1/L2 signaling after the RA procedure. In some embodiments, the RS may be a SSB. In some embodiments, the RS may be a CSI-RS. Of course, the RS may adopt any other suitable forms.

For example, after the RA procedure triggered by the L1/L2 signaling based mobility, UE assumes that a DM-RS antenna port for PDCCH receptions is quasi co-located with a SS/PBCH block or the CSI-RS resource of a TCI state indicated in the L1/L2 signaling (e.g., MAC CE or DCI) which triggers the L1/L2 signaling based mobility.

In some embodiments, applying the process 300 only for the case of CORESET with index 0 is configured.

In some embodiments, a RRC Reconfiguration for candidate cells does not configure CORESET with index 0 for the PDCCH receptions. In some embodiments, for CORESET with index other than 0, one TCI state is configured for UE.

With the process 300, a TCI state indicated in a L1/L2 signaling is used after a RA procedure. Thus, there is also no need for the network to send another L1/L2 signaling to activate the TCI state, and communication latency and overhead is reduced.

### Example Implementation of Ra Partition for L1/L2 Based Mobility

Since the L1/L2 based mobility targets for latency, shorter time is expected. For example, a failure detection timer for reconfiguration with sync (T304) can be configured as a very small value. If traditional RA resource and parameters for RRC based mobility are reused for L1/L2 based mobility, performance of L1/L2 based mobility may not be guaranteed.

In view of this, embodiments of the present disclosure provide a solution for supporting a RA partition for L1/L2 based mobility. This solution will be described in connection with FIG. 4.

FIG. 4 illustrates a schematic diagram illustrating a process 400 of performing a L1/L2 based mobility procedure according to embodiments of the present disclosure. For the purpose of discussion, the process 400 will be described with reference to FIG. 1A. The process 400 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 4, the network device 120 transmits 410, to the terminal device 110, a RA configuration dedicated for a cell change or addition based on a lower-layer signaling (i.e., L1/L2 based mobility). In some embodiments, the network device 120 may transmit the RA configuration in system information. For example, the network device 120 may transmit the RA configuration in system information block 1 (SIB1). It is to be understood that this is merely an example, and any other suitable ways are also feasible.

In some embodiments, the RA configuration may comprise RA resource and parameters. For example, the RA configuration may comprise at least one of the following: a preamble configuration, a RA occasion configuration, a PUSCH configuration for 2-step RA, a reference signal receive power (RSRP) threshold for selection of a RS, a transport block (TB) size threshold in bits below which UE shall use a contention-based RA preamble of group A, or the maximum number of message A transmissions when both 4-step and 2-step RA type random access resources are configured. It is to be understood that these are merely examples, and any other suitable information is also feasible.

In some embodiments, the network device 120 may configure a cell change or addition based on a lower-layer signaling as a feature to be associated with a RA partition. That is, the network device 120 may configure L1/L2 based mobility as one supportive feature to be associated with a RA partition (i.e., an instance of Feature Combination Preambles). For example, Feature Combination may be configured as below.

FeatureCombination-r17 ::= SEQUENCE {

| | | | |
|---|---|---|---|
| redCap | ENUMERATED {true} | OPTIONAL, | -- Need R |
| smallData | ENUMERATED {true} | OPTIONAL, | -- Need R |
| sliceGroup | SliceGroupList | OPTIONAL, | -- Need R |
| covEnh | ENUMERATED {true} | OPTIONAL, | -- Need R |

| | | |
|---|---|---|
| laterThanRel17Features ENUMERATED {true} | OPTIONAL, | -- Need R |
| ... | | |
| [[ | | |
| L1L2mobility-r18 ENUMERATED {true} | OPTIONAL, | -- Need R |
| ]] | | |
| } | | |

Continue to refer to FIG. 4, the network device 120 transmits 420, to the terminal device 110, a lower-layer signaling (i.e., L1/L2 signaling) indicating a cell change or addition for a cell (i.e., a target cell) of the network device 130. The lower-layer signaling further indicates a TCI state for the cell. In some embodiments, the cell change or addition may be a PCell change or addition. In some embodiments, the cell change or addition may be a PSCell change or addition. In some embodiments, the cell change may be a SCell change or addition.

For example, a lower-layer signaling may indicate a cell change from a serving cell of network device 120 to the cell of the network device 130. As another example, a lower-layer signaling may indicate an addition of the cell of the network device 130. The cell may be PCell or PSCell of the terminal device 110. In some embodiments, the lower-layer signaling may be carried in DCI. In some embodiments, the lower-layer signaling may be carried in a MAC CE. Of course, any other suitable forms are also feasible.

Upon reception of the lower-layer signaling, the terminal device 110 performs 430 a RA procedure based on the RA configuration dedicated for L1/L2 based mobility received from system information.

With the process 400, performance of a RA procedure for L1/L2 based mobility may be improved.

### Example Implementation of RLF Report for L/L2 Based Handover

Generally, a RLF report can be used to record information of handover failure and radio link failure. The information is stored upon a failure happens and reported to the network to assist the network to identify a reason of the failure and further adjust a handover configuration. A configuration for L1/L2 based handover is different from other types of handover (e.g. normal handover (HO), conditional handover (CHO) and dual active protocol stack (DAPS) HO. Thus, there is a need to differentiate a L1/L2 based handover from other types of failure.

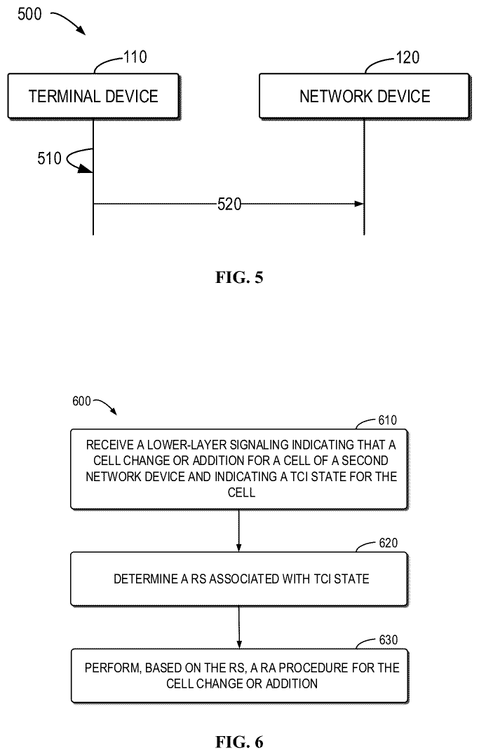

In view of this, embodiments of the present disclosure provide a solution for a RLF report for L1/L2 based mobility. This solution will be described in connection with FIG. 5.

FIG. 5 illustrates a schematic diagram illustrating a process 500 of a RLF report for a L1/L2 based handover according to embodiments of the present disclosure. For the purpose of discussion, the process 500 will be described with reference to FIG. 1A. The process 500 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 5, the terminal device 110 determines 510 whether a RLF report is triggered by a failure of lower-layer signaling based handover. If the RLF report is triggered by the failure of lower-layer signaling based handover, the terminal device 110 transmits 520, to the network device 120, the RLF report comprising an indication that a last handover is the lower-layer signaling based handover.

In some embodiments, if the RLF report is triggered by a radio link failure, the terminal device 110 may determine whether a handover before the radio link failure is a lower-layer signaling based handover. If the handover before the radio link failure is the lower-layer signaling based handover, the terminal device 110 may determine that the RLF report is triggered by the failure in the lower-layer signaling based handover. Then the terminal device 110 may also transmit, to the network device 120, the RLF report comprising the indication that a last handover is the lower-layer signaling based handover. In this case, the failure may be caused by a too early L1/L2 signaling based handover.

With the process 500, the network receiving the RLF report may be aware of the failure is due to improper L1/L2 signaling based handover, and may further adjust parameters for the L1/L2 based handover.

### Example Implementation of Methods

Accordingly, embodiments of the present disclosure provide methods of communication implemented at a terminal device and a network device. These methods will be described below with reference to FIGS. 6 to 13.

FIG. 6 illustrates an example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 610, the terminal device 110 receives, from a first network device (for example, the network device 120), a lower-layer signaling indicating that a cell change or addition for a cell (for example, the cell 131) of a second network device (for example, the network device 130) and indicating a TCI state for the cell.

At block 620, the terminal device 110 determines a RS associated with the TCI state. In some embodiments, if a set of RSs is associated with the TCI state, the terminal device 110 determines, as the RS, a first RS in the set of RSs having a quasi-colocation type of type D. In some embodiments, the RS may be a SSB. In some embodiments, the RS may be a CSI-RS.

At block 630, the terminal device 110 performs, based on the RS, a RA procedure for the cell change or addition.

With the method 600, a RA procedure for L1/L2 based mobility is performed on a fix beam associated with a TCI state indicated in the L1/L2 signaling. Thus, there is no need for the network to send another L1/L2 signaling to activate the TCI state, and communication latency and overhead is reduced.

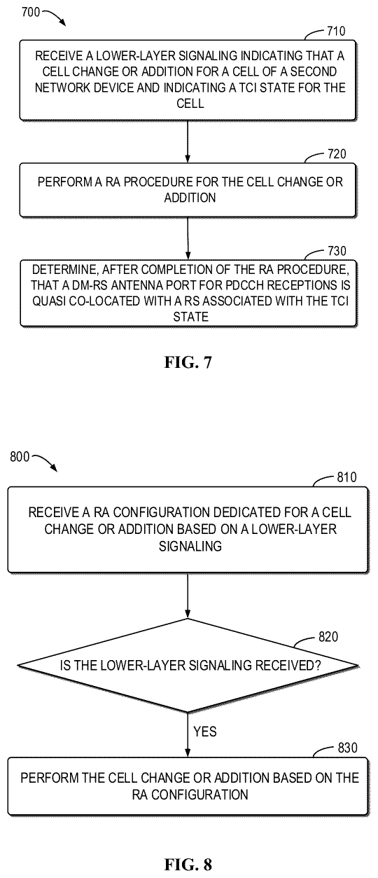

FIG. 7 illustrates another example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 710, the terminal device 110 receives, from a first network device (for example, the network device 120), a lower-layer signaling indicating that a cell change or addition for a cell (for example, the cell 131) of a second network device (for example, the network device 130) and indicating a TCI state for the cell.

At block 720, the terminal device 110 performs a RA procedure for the cell change or addition.

At block 730, the terminal device 110 determines, after completion of the RA procedure, that a DM-RS antenna port for PDCCH receptions is quasi co-located with a RS associated with the TCI state. In some embodiments, the RS may be a SSB. In some embodiments, the RS may be a CSI-RS.

With the method 700, a TCI state indicated in a L1/L2 signaling is used after a RA procedure. Thus, there is also no need for the network to send another L1/L2 signaling to activate the TCI state, and communication latency and overhead is reduced.

FIG. 8 illustrates still another example method 800 of communication implemented at a terminal device in accordance with some embodiments of the present disclosure. For example, the method 800 may be performed at the terminal device 110 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 810, the terminal device 110 receives, from a first network device (for example, the network device 120), a RA configuration dedicated for a cell change or addition based on a lower-layer signaling. In some embodiments, the cell change or addition based on the lower-layer signaling may be configured as a feature to be associated with a random access partition.

At block 820, the terminal device 110 determines whether the lower-layer signaling is received from the network device 120. The lower-layer signaling may indicate that a cell change or addition for a cell (for example, the cell 131) of a second network device (for example, the network device 130). If the lower-layer signaling is received, the method 800 proceeds to block 830.

At block 830, the terminal device 110 performs the cell change or addition based on the RA configuration.

With the method 800, performance of a RA procedure for L1/L2 based mobility may be improved.

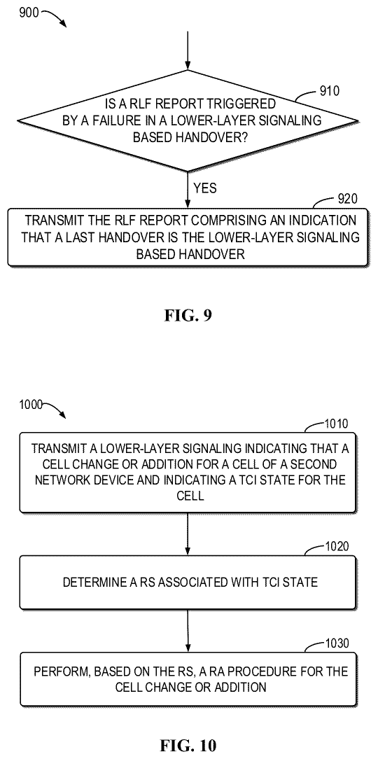

FIG. 9 illustrates yet another example method 900 of communication implemented at a terminal device in accordance with some embodiments of the present disclosure. For example, the method 900 may be performed at the terminal device 110 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 910, the terminal device 110 determines whether a RLF report is triggered by a failure in a lower-layer signaling based handover. If the RLF report is triggered by the failure in the lower-layer signaling based handover, the method of 900 proceeds to block 920.

At block 920, the terminal device 110 transmits, to the network device 120, the RLF report comprising an indication that a last handover is the lower-layer signaling based handover.

In some embodiments, if the RLF report is triggered by a radio link failure, the terminal device 110 may determine whether a handover before the radio link failure is a lower-layer signaling based handover. If the handover before the radio link failure is the lower-layer signaling based handover, the terminal device 110 may determine that the radio link failure report is triggered by the failure in the lower-layer signaling based handover.

With the method 900, a failure due to too early or too late L1/L2 signaling based handover may be reported to the network.

FIG. 10 illustrates an example method 1000 of communication implemented at a network device in accordance with some embodiments of the present disclosure. For example, the method 1000 may be performed at the network device 120 or 130 as shown in FIG. 1A. For the purpose of discussion, in the following, the method 1000 will be described with reference to FIG. 1A. It is to be understood that the method 1000 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 10, at block 1010, a first network device (for example, the network device 120) transmits, to the terminal device 110, a lower-layer signaling indicating that a cell change or addition for a cell of a second network device (for example, the network device 130) and indicating a TCI state for the cell.

At block 1020, the network device 120 determines a RS associated with the TCI state. In some embodiments, if a set of RSs is associated with the TCI state, the network device 120 determines, as the RS, a first RS in the set of RSs having a quasi-colocation type of type D. In some embodiments, the RS may be a SSB. In some embodiments, the RS may be a CSI-RS.

At block 1030, the network device 120 performs, based on the RS, a RA procedure for the cell change or addition.

With the method 1000, a RA procedure for L1/L2 based mobility is performed on a fix beam associated with a TCI state indicated in the L1/L2 signaling. Thus, there is no need for the network to send another L1/L2 signaling to activate the TCI state, and communication latency and overhead is reduced.

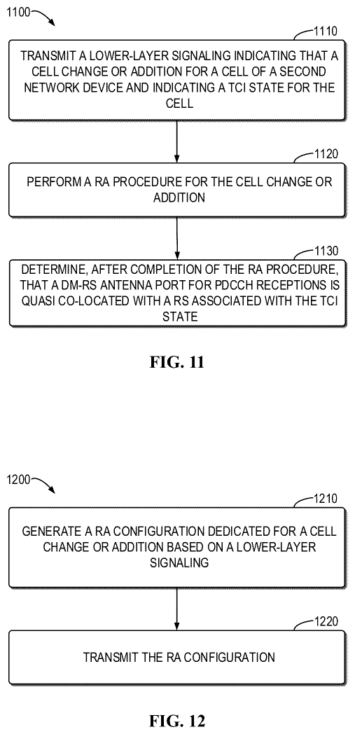

FIG. 11 illustrates another example method 1100 of communication implemented at a network device in accordance with some embodiments of the present disclosure. For example, the method 1100 may be performed at the network device 120 or 130 as shown in FIG. 1A. For the purpose of discussion, in the following, the method 1100 will be described with reference to FIG. 1A. It is to be understood that the method 1100 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 11, at block 1110, a first network device (for example, the network device 120) transmits, to the terminal device 110, a lower-layer signaling indicating that a cell change or addition for a cell of a second network device (for example, the network device 130) and indicating a TCI state for the cell.

At block 1120, the network device 120 performs a RA procedure for the cell change or addition.

At block 1130, the network device 120 determines, after completion of the RA procedure, that a DM-RS antenna port for PDCCH transmissions is quasi co-located with a RS associated with the TCI state. In some embodiments, the RS may be a SSB. In some embodiments, the RS may be a CSI-RS.

With the method 1100, a TCI state indicated in a L1/L2 signaling is used after a RA procedure. Thus, there is also no need for the network to send another L1/L2 signaling to activate the TCI state, and communication latency and overhead is reduced.

FIG. 12 illustrates still another example method 1200 of communication implemented at a network device in accordance with some embodiments of the present disclosure. For example, the method 1200 may be performed at the network device 120 or 130 as shown in FIG. 1A. For the purpose of discussion, in the following, the method 1200 will be described with reference to FIG. 1A. It is to be understood that the method 1200 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 12, at block 1210, a first network device (for example, the network device 120) generating a RA configuration dedicated for a cell change or addition based on a lower-layer signaling. In some embodiments, the cell change or addition based on the lower-layer signaling may be configured as a feature to be associated with a random access partition.

At block 1220, the network device 120 transmits the RA configuration to the terminal device 110.

With the method 1200, a dedicated RA configuration is configured and performance of a RA procedure for L1/L2 based mobility may be improved.

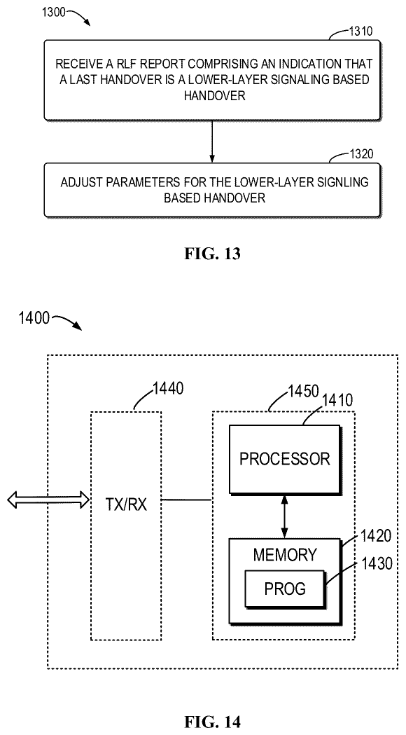

FIG. 13 illustrates yet another example method 1300 of communication implemented at a network device in accordance with some embodiments of the present disclosure. For example, the method 1300 may be performed at the network device 120 or 130 as shown in FIG. 1A. For the purpose of discussion, in the following, the method 1300 will be described with reference to FIG. 1A. It is to be understood that the method 1300 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 13, at block 1310, a first network device (for example, the network device 120) receives, from the terminal device 110, a RLF report comprising an indication that a last handover is a lower-layer signaling based handover.

At block 1320, the network device 120 adjusts parameters for the lower-layer signaling based handover.

With the method 1300, the network may be aware of a failure due to too early or too late L1/L2 signaling based handover and may further adjust the parameters of the L1/L2 signaling based handover.

It is to be understood that the operations of methods 600 to 1300 are similar as that described in connection with FIGS. 2 to 5, and thus other details are not repeated here for concise.

### Example Implementation of Devices and Apparatuses

FIG. 14 is a simplified block diagram of a device 1400 that is suitable for implementing embodiments of the present disclosure. The device 1400 can be considered as a further example implementation of the terminal device 110 or the network device 120 or the network device 130 as shown in FIG. 1A. Accordingly, the device 1400 can be implemented at or as at least a part of the terminal device 110 or the network device 120 or the network device 130.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1A to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device comprises a circuitry configured to: receive, from a first network device, a lower-layer signaling indicating a cell change or addition for a cell of a second network device and indicating a transmission configuration indicator state for the cell; determine a reference signal associated with the transmission configuration indicator state; and perform, based on the reference signal, a random access procedure for the cell change or addition.

In some embodiments, the circuitry may be configured to determine the reference signal by: in accordance with a determination that a set of reference signals is associated with the transmission configuration indicator state, determining, as the reference signal, a first reference signal in the set of reference signals having a quasi-colocation type of type D.

In some embodiments, a terminal device comprises a circuitry configured to: receive, from a first network device, a lower-layer signaling indicating a cell change or addition for a cell of a second network device and indicating a transmission configuration indicator state for the cell; perform a random access procedure for the cell change or addition; and determine, after completion of the random access procedure, that a demodulation reference signal antenna port for physical downlink control channel receptions is quasi co-located with a reference signal associated with the transmission configuration indicator state. In some embodiments, the reference signal is a SSB or a CSI-RS.

In some embodiments, a terminal device comprises a circuitry configured to: receive, from a network device, a random access configuration dedicated for a cell change or addition based on a lower-layer signaling; and in response to receiving the lower-layer signaling, perform the cell change or addition based on the random access configuration.

In some embodiments, the cell change or addition based on the lower-layer signaling is configured as a feature to be associated with a random access partition.

In some embodiments, a terminal device comprises a circuitry configured to: determine whether a radio link failure report is triggered by a failure in a lower-layer signaling based handover; and in accordance with a determination that the radio link failure report is triggered by the failure in the lower-layer signaling based handover, transmit, to a network device, the radio link failure report comprising an indication that a last handover is the lower-layer signaling based handover.

In some embodiments, the circuitry may be configured to determine whether the radio link failure report is triggered by the failure in the lower-layer signaling based handover by: in accordance with a determination that the radio link failure report is triggered by a radio link failure, determining whether a handover before the radio link failure is a lower-layer signaling based handover; and in accordance with a determination that the handover before the radio link failure is the lower-layer signaling based handover, determining that the radio link failure report is triggered by the failure in the lower-layer signaling based handover.

In some embodiments, a first network device comprises a circuitry configured to: transmit, to a terminal device, a lower-layer signaling indicating a cell change or addition for a cell of a second network device and indicating a transmission configuration indicator state for the cell; determine a reference signal associated with the transmission configuration indicator state; and perform, based on the reference signal, a random access procedure for the cell change or addition.

In some embodiments, the circuitry may be configured to determine the reference signal by: in accordance with a determination that a set of reference signals is associated with the transmission configuration indicator state, determining, as the reference signal, a first reference signal in the set of reference signals having a quasi-colocation type of type D.

In some embodiments, a first network device comprises a circuitry configured to: transmit, to a terminal device, a lower-layer signaling indicating a cell change or addition for a cell of a second network device and indicating a transmission configuration indicator state for the cell; perform a random access procedure for the cell change or addition; and determine, after completion of the random access procedure, that a demodulation reference signal antenna port for physical downlink control channel transmissions is quasi co-located with a reference signal associated with the transmission configuration indicator state.

In some embodiments, the reference signal is a SSB or a CSI-RS.

In some embodiments, a first network device comprises a circuitry configured to: generate a random access configuration dedicated for a cell change or addition based on a lower-layer signaling; and transmit the random access configuration to a terminal device.

In some embodiments, the cell change or addition based on the lower-layer signaling is configured as a feature to be associated with a random access partition.

In some embodiments, a network device comprises a circuitry configured to: receive, from a terminal device, a radio link failure report comprising an indication that a last handover is a lower-layer signaling based handover; and adjusting parameters for the lower-layer signaling based handover.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-17. (canceled)

18. A method of a User Equipment (UE) comprising:
receiving, from a base station, a Medium Access Control (MAC) Control Element (CE) triggering cell switch to a target cell, wherein the MAC CE comprises information indicating a Transmission Configuration Indicator (TCI) state,
performing a random access procedure towards the target cell, and
applying, after completion of the random access procedure for Layer1/Layer2 triggered mobility, the TCI State for reception.

19. The method of claim 18, further comprising:
assuming that Demodulation Reference Signal (DM-RS) antenna ports for Physical Downlink Control Channel (PDCCH) receptions is quasi co-located with a synchronization signals and physical broadcast channel (SS/PBCH) block in the TCI state.

20. The method of claim 18, wherein:
the TCI state provided by the MAC CE is related to quasi co-location type of type D.

21. A User Equipment (UE) comprising:
a memory storing instructions; and
a processor configured to execute the instructions to:
receive, from a base station, a Medium Access Control (MAC) Control Element (CE) triggering cell switch to a target cell, wherein the MAC CE comprises information indicating a Transmission Configuration Indicator (TCI) state,
perform a random access procedure towards the target cell, and
apply, after completion of the random access procedure for Layer1/Layer2 triggered mobility, the TCI State for reception.

22. The UE of claim 21, wherein the processor is further configured to execute the instruction to:
assume that Demodulation Reference Signal (DM-RS) antenna ports for Physical Downlink Control Channel (PDCCH) receptions is quasi co-located with a synchronization signals and physical broadcast channel (SS/PBCH) block in the TCI state.

23. The UE of claim 21, wherein:
the TCI state provided by the MAC CE is related to quasi co-location type of type D.
